(19) United States
(12) Patent Application Publication
(10) Pub. No.: US 2025/0291026 A1
(43) Pub. Date: Sep. 18, 2025

(54) METHOD FOR CONTROLLING A COHERENT COOPERATIVE RADAR SENSOR NETWORK

(71) Applicant: Robert Bosch GmbH, Stuttgart (DE)

(72) Inventors: Daniel Schindler, Korntal-Münchingen (DE); Tobias Schmid, Fluorn-Winzeln (DE)

(21) Appl. No.: 18/860,234

(22) PCT Filed: Jul. 3, 2023
(86) PCT No.: PCT/EP2023/068182

§ 371 Date: Oct. 25, 2024

(30) Foreign Application Priority Data
Sep. 28, 2022 (DE) 10 2022 210 263.0

(51) Int. Cl. G01S 7/288; G01S 7/35; G01S 13/42; G01S 13/58; G01S 13/87

(52) U.S. Cl. CPC G01S 7/288; G01S 7/356; G01S 13/42; G01S 13/584; G01S 13/87; G01S 13/582

(57) ABSTRACT

A method for controlling a coherent cooperative radar sensor network including a plurality of radar sensors. At least two sensors operate coherently. The sensor data are partitioned according to the type of evaluation into data to be evaluated coherently and data to be evaluated non-coherently. The data to be evaluated coherently and the data to be evaluated non-coherently are transmitted to respectively different evaluation units, which then each carry out an evaluation. The individual evaluations are combined to form an overall evaluation.

### FIELD

The present invention relates to a method for controlling a coherent cooperative radar sensor network. The present invention also relates to a coherent cooperative radar sensor network that carries out said method.

### BACKGROUND INFORMATION

German Patent Application No. DE 10 2015 224 787 A1 describes a coherent cooperative radar sensor network consisting of at least two radar sensors. The radar sensors are synchronized with one another, either by exchanging data or via a signal. Each radar sensor transmits information about the radar signals to a processing device. The processing device can be external or it can be integrated into one of the radar sensors. The processing device processes the received information and preferably determines both bistatic and monostatic distances to an object.

German Patent Application No. DE 10 2019 220 238 A1 describes a coherent cooperative radar sensor network consisting of at least two radar sensors and a method for calibrating it. A phase control signal is transmitted between the radar sensors and a radar signal is sent based on the phase control signal. An evaluation unit evaluates the received signals of the radar sensors.

The radar signals are evaluated in the usual manner centrally in a single evaluation unit. This applies to both coherent data and non-coherent data. The evaluation unit can also be part of a radar sensor, to which the data from the remaining radar sensors is then sent.

For a non-coherent radar sensor network, it is also conventional to evaluate the non-coherent data decentrally in the radar sensors.

### SUMMARY

According to the present invention, a method for controlling a coherent cooperative radar sensor network is provided. The coherent cooperative radar sensor network comprises a plurality of interconnected and cooperating radar sensors. At least two sensors, and preferably all of the sensors, operate coherently. Non-coherent cooperative sensors can be provided as well, however.

According to an example embodiment of the present invention, the intent is to partition the sensor data to be evaluated in order to evaluate them in different evaluation units. The evaluation units can be physical computing devices or processors or they can be implemented as virtual cores or software blocks. The sensor data are partitioned according to the type of evaluation into data to be evaluated coherently (hereinafter also referred to as coherent data) and data to be evaluated non-coherently (hereinafter also referred to as non-coherent data). This preferably includes a calculation of the (two-dimensional) spectrum. The partitioning is then based on the spectrum. This ascertains regions that are advantageously evaluated coherently or non-coherently. The complex, spectral samples are then distributed in accordance with the regions. In the case of frequency-modulated continuous wave radar (FMCW), the partitioning can also be carried out by means of filtering based on a time signal. The coherent data are obtained from high-pass filtering and the non-coherent data are obtained from low-pass filtering. The data to be evaluated coherently and the data to be evaluated non-coherently are transmitted to respectively different evaluation units. The data are then available at the evaluation units, which then each carry out an evaluation of their data. The non-coherent data are thus evaluated by at least one evaluation unit and the coherent data are evaluated separately by at least one other evaluation unit. The individual evaluations are then combined to form an overall evaluation, which is carried out in one evaluation unit.

Partitioning the data distributes the computational effort to several evaluation units and the individual evaluations can be carried out in parallel, so that the respective evaluation units don't have to muster as much computing power or the overall efficiency increases.

According to an example embodiment of the present invention, the evaluation of the non-coherent data includes acquiring the vectorial speed, for example, and/or creating a common target list (location aggregation). The evaluation of the coherent data can include a phase and/or frequency synchronization via the antenna array and/or an angle estimation. In this respect, reference is made to German Patent Application No. DE 10 2019 220 238 A1.

According to an example embodiment of the present invention, the allocation of the evaluation units to the data is preferably carried out on the basis of the expected computational effort, or the expected required computing power for the data of the respective type of evaluation, in order to balance the computational effort required to evaluate the respective data set across the evaluation units. For instance, the evaluation of the coherent data requires more computing power than the evaluation of the non-coherent data. The number of evaluation units and/or the computing power of the evaluation unit is therefore preferably in particular selected depending on the type of evaluation.

According to an example embodiment of the present invention, it is preferably provided that the partitioned data have the same data volume in order to achieve a constant data rate. This is relevant in particular in the case of multiple cooperative sensors (for example four or more sensors). In that case, the coherent portion and/or the non-coherent portion could be partitioned even further. The threshold values are preferably dynamically adapted to the data.

In the overall evaluation, the data from the individual evaluations for each target are combined in one evaluation unit. Thus ultimately all of the antenna combinations of the transmitting and receiving antennas of all of the sensors are evaluated together, which is what is required, for instance for a cooperative angle calculation.

According to an example embodiment of the present invention, further partitioning of the sensor data to be evaluated can be provided. The sensor data can be partitioned according to one or more of the following criteria for the radar signal being used:
distance ranges—a distance threshold value can be set here for the partitioning;
Doppler/speed ranges—the speed can be ascertained from the Doppler shift, so the Doppler shift can either be used directly as a criterion or a speed threshold value can be set; and
angular ranges.

The criteria represent meaningful sectional planes for the sensor data. It is also possible to use combinations of the criteria for the partitioning. The partitioning into coherent and non-coherent data and the partitioning into distance ranges can advantageously in particular be combined, because a coherent angle evaluation can only be meaningfully carried out from a specific distance in which the assumption for the far field applies.

The mentioned threshold values can be optimized depending on data rate, computing power, computing operations, etc. The common separation plane is preferably determined prior to the exchange of information. A handshake protocol between the sensors can be carried out for this purpose, for example. The smallest threshold value can always be used for the partitioning, for instance. It is preferably provided that the sections have the same data volume in order to achieve a constant data rate. This is relevant in particular if specific regions include more targets than others as a result of the partitioning. The threshold values are preferably dynamically adapted to the data.

According to an example embodiment of the present invention, the data of the different criteria are then transmitted to different evaluation units. The evaluation units then each carry out an evaluation of their data. The individual evaluations are then combined to form an overall evaluation, which is carried out in one evaluation unit. Partitioning the data distributes the computational effort to several evaluation units and the individual evaluations can be carried out in parallel, so that the respective evaluation units don't have to muster as much computing power.

According to an example embodiment of the present invention, the sensor data can be transmitted to a data distribution unit for partitioning. The data distribution unit partitions the sensor data as described above and then distributes said data to the evaluation units accordingly. The data distribution unit can be part of one or more of the sensors or can be configured as a separate unit.

Radar sensors nowadays often already comprise evaluation units. The data can in particular be distributed to the evaluation units in the radar sensors. The aforementioned data distribution unit can preferably be used for this purpose. This then requires a bidirectional connection to the sensors. The evaluation units in the radar sensors then carry out the evaluation of their data. This results in the advantage that there is no need for a central computing device, because the evaluation can be carried out directly in the radar sensors.

The overall data rate between the evaluation units is moreover reduced compared to a centralized evaluation. Part of the data remains in the sensor or in its evaluation unit until it has been fully evaluated. If the data load between N evaluation units is the same, the following relationship applies for the data rate in both cases:

$${R}_{decentralized} = ( 1 - \frac{1}{N} ) {R}_{centralized}$$

As an example for three sensors, the overall data rate is reduced by 1/3 compared to a centralized evaluation.

Since the data in the evaluation units of the radar sensors can be discarded or overwritten only after complete exchange, a data buffer is preferably provided. If the data volume D_{sensor_data} is the same, the size of the buffer D_{buffer} can be estimated using the following relationship:

$${D}_{buffer} = \frac{1}{N} {D}_{sensor\_data}$$

As an example for three evaluation units, the size of the buffer is thus reduced to at least 1/3 compared to a central evaluation unit. The buffering can also be done in the aforementioned data distribution unit in addition to the partitioning of the data.

According to an example embodiment of the present invention, alternatively or additionally, a central computing device comprising a plurality of evaluation units can be provided. The data are transmitted to the central computing device and partitioned there to the various evaluation units. The partitioning can be carried out by the aforementioned data distribution unit, which can also be embodied in one or more of the sensors, as a separate unit or as part of the central computing device. The multiple evaluation units within the central computing device then carry out the evaluation of their data. The data from each sensor can be evaluated separately from one another up to an angle estimation. The multiple evaluation units are in particular different processors of the computing device or are implemented as virtual cores or as software blocks. The evaluation units of the central computing device preferably access a central memory, so that the data are available to each evaluation unit. Alternatively, a memory can be provided for each evaluation unit or for a group of evaluation units.

If there are evaluation units in the sensors and also a central computing device comprising multiple evaluation units, it is preferably provided that the sensor data to be evaluated non-coherently are transmitted to the evaluation unit of the non-coherent radar sensor, because this requires less computing power. The sensor data to be evaluated coherently can then be transmitted to the central computing device, the more powerful evaluation units of which take over the evaluation with higher computational effort.

According to one aspect of the present invention, the sensor data can be transmitted as raw data by the sensors. This makes it possible to use simple sensor heads that provide raw data, e.g. analog-to-digital converter data. This raw data can optionally be decimated prior to transmission. Alternatively, Fourier-transformed data, such as range FFT data, Doppler FFT data, and/or range Doppler FFT data can be transmitted. This makes it possible to use simple and cost-efficient radar sensors that, for raw data, do not need a preprocessing unit, and, for Fourier-transformed data, need only a simple preprocessing unit that carries out the Fourier transformation. If there is a central computing device for the evaluation, the radar sensors do not also need an evaluation unit. All of the information for all of the targets is moreover transmitted via the raw data or the Fourier-transformed data. This leads to a high data rate for the transmission, but not there is no loss of information. If only raw data are transmitted, measures that typically take place during preprocessing, such as a distance and/or Doppler evaluation using fast Fourier transformation, can be carried out during the evaluation.

A non-coherent integration (NCI) based on several sensors can be carried out during the overall evaluation. The NCI calculation can be carried out for both coherent and non-coherent data. Preferably, a joint NCI calculation is carried out for targets with far-field condition, because it can be assumed that these targets can be detected by multiple sensors in the same distance-speed cell. For the close range (non-coherent range), the NCI calculation is preferably carried out individually on the basis of the data of the individual sensors or the bistatic measurements. With individual evaluation, there is a risk that targets will not be detected by the individual sensor. Before the data are permanently discarded, the missing targets of individual sensors or bistatic measurements can be detected retrospectively by the central NCI calculation. This achieves a higher integration gain for downstream target detection, e.g. using a constant false alarm rate (CFAR) compared to individual evaluation. As a result, the sensitivity and range of the cooperative sensor network are increased. Lastly, further signal processing steps typical for the respective data type, such as an angle evaluation and/or a speed evaluation, and non-coherent processing steps (e.g. ascertaining a vectorial speed and/or creating a common target list) are carried out on the basis of the multiple or individual sensors. The signal processing steps for coherent and non-coherent evaluations are named the same, but are carried out differently. Preferably, the angle evaluation for the coherent data can be carried out based on all of the sensors; for non-coherent data, the angle evaluation can be carried out based on the individual sensor data. Preferably, the speed evaluation for the coherent data can be carried out in the conventional manner; for the non-coherent data, the speed evaluation can additionally be supplemented by a vectorial speed evaluation. This represents an additional evaluation result. The joint result can be output in the form of a target list, for example.

According to a further aspect of the present invention, the sensor data can be preprocessed in the sensors before they are transmitted. A preprocessing unit can be provided in the sensors for this purpose or the above-described evaluation unit can be used in the sensors. The preprocessed sensor data are then transmitted and partitioned and evaluated as described above.

According to a further aspect of the present invention, the sensor data can be transmitted to the evaluation units. The evaluation unit can be integrated in the sensors or can be configured in a central computing device. The preprocessing is then carried out in the evaluation units. The sensor data are preferably preprocessed in the evaluation units in which the evaluation also takes place. The preprocessed sensor data can alternatively be transmitted and partitioned as described above.

According to an example embodiment of the present invention, in one type of preprocessing, a distance and/or Doppler evaluation is carried out in each sensor or in each evaluation unit, for example using fast Fourier transformation (FFT) or using discrete Fourier transformation (DFT). An adapted evaluation with a constant false alarm rate (CFAR) is carried out as well in each sensor with this data, which enables an acquisition of targets, i.e. target detection. The adapted CFAR uses a higher false alarm rate than conventional methods. Due to the higher false alarm rate comparatively more targets are detected. The higher false alarm rate should be selected such that ideally all of the targets are detected, so that no information about targets in the scene acquired by the sensors is discarded. The preprocessed sensor data are then transmitted. The data rate for the transmission of the preprocessed data is thus reduced considerably, for example by a factor of 10, compared to the transmission of raw data.

According to an example embodiment of the present invention, in the overall evaluation, an evaluation with a lower constant false alarm rate is advantageously carried out on the basis of all of the sensors. The term “lower” refers here to the comparison with the above-described CFAR. Preferably, the usual parameterizations are used for this CFAR. The common targets are thus acquired in the usual way. A non-coherent integration (NCI) can also be carried out based on multiple sensors in the spectral ranges in which data was transmitted by more than one sensor, as described above. This achieves a significantly higher integration gain than individual evaluation. Lastly, as described above, further signal processing steps typical for the respective data type, such as an angle evaluation and/or a speed ascertainment, and non-coherent processing steps (e.g. ascertaining a vectorial speed and/or creating a common target list) are carried out on the basis of the multiple or individual sensors.

According to an example embodiment of the present invention, during preprocessing, each sensor or each evaluation unit decides independently which data are discarded. It can therefore happen that some of the sensors may not transmit any sensor data. However, angle determination with incomplete data is disadvantageous for the overall evaluation of the coherent cooperative radar network. Preferably, a quality criterion is introduced, which is used to decide whether targets that were acquired by only some of the radar sensors are evaluated. Such a quality criterion can be a majority decision of the sensors, for example. If the quality criterion is met, the partially acquired targets are evaluated. In this case, it can be provided that the angle evaluation is carried out with only a subset of the radar sensors. The targets can be aggregated to evaluate the non-coherent data.

According to an example embodiment of the present invention, in another type of preprocessing of the sensor data, a distance and Doppler evaluation is carried out in each sensor or in each evaluation unit. A complete evaluation with a constant false alarm rate is then carried out in each sensor or in each evaluation unit. Preferably, the usual parameterizations are used for this CFAR. The common targets are thus acquired in the usual way. Targets can be discarded here in comparison with the raw data and the evaluation with a lower CFAR. A peak search can be carried out too and, if necessary, neighboring regions of the peak values can also be transmitted preprocessed and/or evaluated. An angle estimation is furthermore carried out in each sensor or in each evaluation unit based on the sensor data of the individual sensors and/or the bistatic measurement paths. This provides a roughly estimated angle. The result of this preprocessing is stored in a target list that also contains phase information. This additional information relates to the relative phase positions of the individual transmitter-receiver antenna channels for each target and is available as the complex amplitude of all of the virtual channels. The target list with the phase information is transmitted as preprocessed sensor data.

According to an example embodiment of the present invention, the target lists of the individual sensors or the individual evaluation units can be merged during the overall evaluation. A CFAR and/or a peak search can also be carried out again in order to reduce the amount of data. If multiple preprocessed sensor data provide the same target (e.g. the same distance and Doppler data, and possibly also the same angles or angular ranges), a cooperative angle estimation can be carried out based on the target lists. As a result, the computational effort for the overall evaluation and ideally for the evaluation of the coherent data is significantly reduced. The data rate for the transmission of the preprocessed data is thus reduced considerably, for example by a factor of 1000, compared to the transmission of raw data. In the evaluation of the individual sensors and the subsequent cooperative evaluation, the cooperative integration gain prior to the CFAR is comparatively low. Lastly, as described above, further signal processing steps typical for the respective data type are carried out on the basis of the single or multiple sensors.

According to an example embodiment of the present invention, the roughly estimated angle obtained during the above-described preprocessing can be determined in more detail during the overall evaluation by means of a refinement, because relative phase positions of the transmit-receive antenna channels are available in all of the target lists. For this purpose, a coherent cooperative angle estimation is carried out in a definable range around the at least one estimated angle with a higher angular resolution. This can be done using a fast Fourier transformation or a Bartlett estimator or a maximum likelihood method, for instance. Since the angular range in which the higher angular resolution is applied is strongly limited, e.g. within the separation capability of the individual sensors in elevation and azimuth, the computational effort for this evaluation is comparable to a conventional angle estimation of a single sensor over the entire angular range. This evaluation can in particular also be used to find and separate multiple targets in the angular range. Normally, the result of this angle estimation can replace the rough angle estimation of the sensors or the evaluation units. If a quality value of the cooperative evaluation is not achieved, the angle estimation of the individual sensors or the evaluation units can be used. The quality value can be obtained as a result of the correlation between a control matrix and the complex amplitude, for instance. For this purpose, meta information about the type of processing can be appended to the target list.

According to an example embodiment of the present invention, the computer program is configured to carry out each step of the method, in particular when it is carried out on a computing device. It enables the implementation of the method in a conventional computing device without having to make any structural changes. For this purpose, it is stored on the machine-readable storage medium.

According to an example embodiment of the present invention, a coherent cooperative radar sensor network comprising a plurality of radar sensors is proposed as well. At least two sensors operate coherently. The radar sensor network also comprises a data distribution unit with which sensor data can be distributed. The data distribution unit can be part of one or more of the sensors. The radar network is configured to carry out the steps of the above-described method.

The coherent cooperative radar sensor network can also comprise a central computing device. The central computing device is configured to carry out the steps of the above-described method.

For this purpose, the central computing device can comprise the data distribution unit.

### BRIEF DESCRIPTION OF THE DRAWINGS

Embodiment examples of the present invention are shown in the figures and explained in more detail in the following description.

FIG. 1 shows a schematic diagram of the data and its partitioning, according to an example embodiment of the present invention.

FIG. 2 shows a systematic diagram of a coherent cooperative radar sensor network according to one embodiment of the present invention.

FIG. 3 shows a systematic diagram of a coherent cooperative radar sensor network according to another embodiment of the present invention.

FIG. 4 shows an angle diagram of the azimuth and elevation angles for estimating the angle of a target.

### DETAILED DESCRIPTION OF EXAMPLE EMBODIMENTS

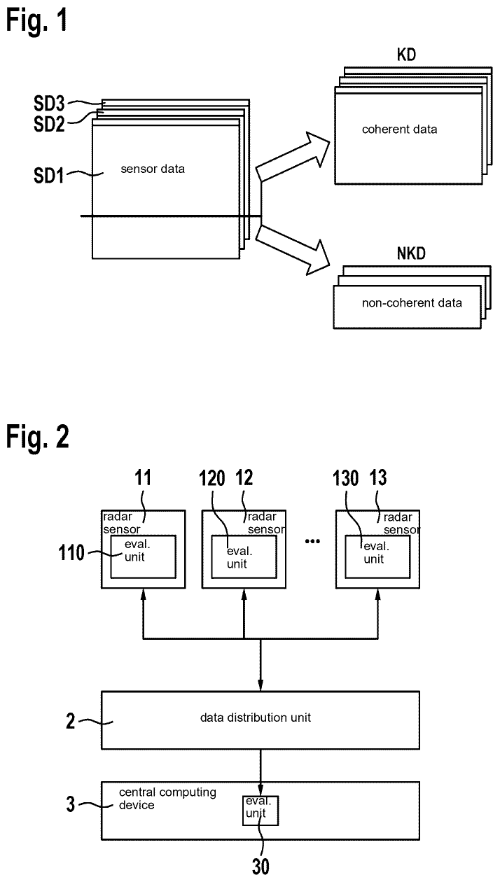

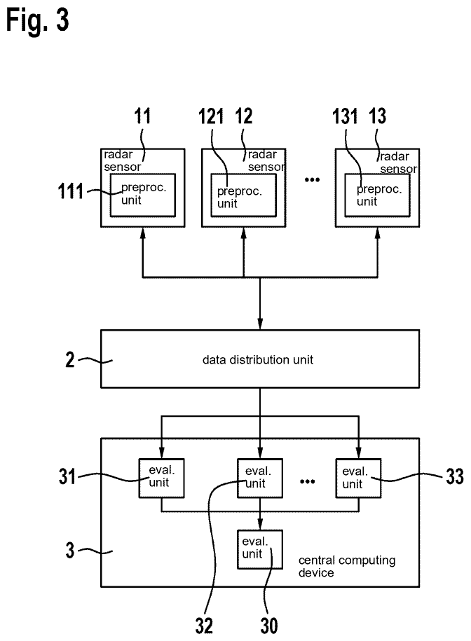

FIG. 1 shows the basic features of the method according to the present invention in a schematic diagram of data. FIGS. 2 and 3 each show a coherent cooperative radar sensor network comprising a plurality of radar sensors (three of which are shown) 11, 12, 13. In this example, a first radar sensor 11 is configured as a non-coherent sensor, a second radar sensor 12 and a third radar sensor 13 are configured coherently. In other embodiment examples, all of the radar sensors 11, 12, 13 can be configured coherently. Sensor data SD1, SD2, SD3, that were acquired by the radar sensors 11, 12, 13, are partitioned by a data distribution unit 2 according to their type of evaluation, i.e. whether they are evaluated coherently or non-coherently. The (two-dimensional) spectrum can be calculated beforehand and the partitioning can be based on the spectrum. This ascertains regions that are advantageously evaluated coherently or non-coherently. In the case of frequency-modulated continuous wave radar (FMCW), the partitioning can be carried out by means of filtering. Coherent data KD are obtained by means of high-pass filtering and non-coherent data NKD are obtained by means of low-pass filtering. The coherent data KD and the non-coherent data NKD are distributed to different evaluation units 110, 120, 130; 31, 32, 33 and evaluated there. In this respect, reference is made to FIGS. 2 and 3. From the non-coherent data, NKD a vectorial speed is ascertained, for example, and/or a common target list is created. For the coherent data KD, a phase and/or frequency synchronization is carried out via the antenna array, for example, and an angle estimation is carried out as well.

The data can also be partitioned according to distance ranges, Doppler/speed ranges and/or angular ranges of the radar signal being used and distributed to the evaluation units 110, 120, 130, 31, 32, 33, which then carry out the evaluation of their data.

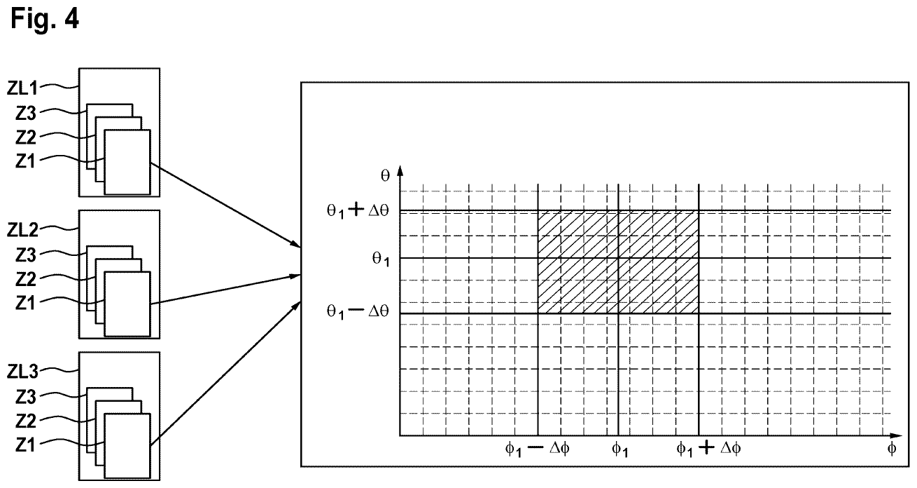

In FIG. 2, the radar sensors 11, 12, 13 each comprise an evaluation unit 110, 120, 130, which carry out a preprocessing of the sensor data SD1, SD2, SD3. Alternatively, raw data and/or Fourier-transformed data, such as range FFT data, Doppler FFT data and/or range Doppler FFT data can be transmitted as well, and the corresponding steps can be carried out later in the evaluation. The preprocessed sensor data SD1, SD2, SD3 include target lists ZL1, ZL2, ZL3 (see FIG. 4) with the respective targets Z1, 22, 23. The preprocessed sensor data SD1, SD2, SD3 (or the raw data and/or the Fourier-transformed data) is transmitted to a data distribution unit 2. The data distribution unit 2 is configured here as a separate unit, but can also be part of a radar sensor 11, 12, 13. The data distribution unit 2 partitions the data as described above in connection with FIG. 1 and transmits them to the evaluation units 120, 130, 140 of the radar sensors 11, 12, 13. Between the radar sensors 11, 12, 13 and the data distribution unit 2 there is a bidirectional connection. The non-coherent data NKD are sent to the evaluation unit 110 of the first radar sensor 11. This applies in particular if the data distribution unit 2 is part of the radar sensors 11, 12, 13. The coherent data KD are separated according to targets or partial spectra of the selected regions and partitioned accordingly and transmitted to the evaluation unit 120 of the second radar sensor 12 and to the evaluation unit 130 of the third radar sensor 13, which operate coherently. The evaluation units 110, 120, 130 then evaluate their data as described above in connection with FIG. 1. The evaluated data are then once more transmitted via the data distribution unit 2 to a central computing device 3. The central computing device 3 comprises an evaluation unit 30 which generates a common evaluation result. This can alternatively also take place in one of the evaluation units 110, 120, 130 of the radar sensors 11, 12, 13.

In FIG. 3, the radar sensors 11, 12, 13 each comprise a preprocessing unit 111, 121, 131, which carry out a preprocessing of the sensor data SD1, SD2, SD3. Alternatively, raw data and/or Fourier-transformed data, such as range FFT data, Doppler FFT data and/or range Doppler FFT data can be transmitted as well, and the corresponding steps can be carried out later in the evaluation. The preprocessed sensor data SD1, SD2, SD3 include target lists ZL1, ZL2, ZL3 (see FIG. 4) with the respective targets Z1, 22, 23. The preprocessed sensor data SD1, SD2, SD3 (or the raw data and/or the Fourier-transformed data) is transmitted to a data distribution unit 2. A central computing device 3, which comprises a plurality of evaluation units 30, 31, 32, 33, is provided as well. The evaluation units 30, 31, 32, 33 can, for instance, be processors, virtual cores or software blocks. The data distribution unit 2 is configured here as a separate unit, but can also be part of the central computing device 3. The data distribution unit 2 partitions the data as described above in connection with FIG. 1 and transmits them to the evaluation units 31, 32, 33 of the central computing device 3. The connections between the radar sensors 11, 12, 13 and the data distribution unit 2 and between the data distribution unit 2 and the central computing device 3 can be configured as simple connections. The non-coherent data NKD are sent to the evaluation unit 31 purely as an example. The coherent data KD are separated according to targets or partial spectra of selected regions and partitioned accordingly and transmitted to the evaluation unit 32 and 33. The evaluation units 31, 32, 33 then evaluate their data as described above in connection with FIG. 1. The evaluated data are then transmitted to the evaluation unit 30, which carries out an overall evaluation of the combined evaluations.

FIG. 4 shows three target lists ZL1, ZL2, ZL3 for the three radar sensors 11, 12, 13. In this example, these each have three targets Z1, 22, Z3. At least the first target Z1 should be the same in the three target lists ZL1, ZL2, ZL3 of the three radar sensors 11, 12, 13. An angle diagram of the azimuth angle ϕ and the elevation angle θ is provided. During preprocessing, the first radar sensor 11 estimated an azimuth angle ϕ₁ and an elevation angle θ₁ for the first target Z1 using a rough angle estimation with low resolution. The overall evaluation includes a coherent cooperative angle estimation for all of the radar sensors 11, 12, 13. Since the rough angles ϕ₁ and θ₁ are already known, the angle estimation is carried out with a higher angular resolution in a definable area around them. The higher angular resolution is represented by the smaller meshed grid in FIG. 4. The limits of the range are selected for the azimuth angle ϕ as ϕ₁-Δϕ and ϕ₁+Δϕ and for the elevation angle θ as θ₁-Δθ and θ₁+Δθ.

1-17. (canceled)

18. A method for controlling a coherent cooperative radar sensor network which includes a plurality of radar sensors, wherein at least two of the radar sensors operate coherently, the method comprising the following steps:
partitioning sensor data of the radar sensors according to a type of evaluation into data to be evaluated coherently and data to be evaluated non-coherently;
transmitting the data to be evaluated coherently and the data to be evaluated non-coherently to respectively different evaluation units, which then each carry out an individual evaluation; and
combining the individual evaluations to form an overall evaluation.

19. The method according to claim 18, wherein the sensor data are partitioned according to distance ranges, Doppler/speed ranges and/or angular ranges of a radar signal being used and the data of the different ranges are transmitted to different evaluation units, which then each carry out an individual evaluation, and wherein the individual evaluations are combined to form an overall evaluation.

20. The method according to claim 18, wherein the sensor data are transmitted to a data distribution unit, the sensor data are partitioned by the data distribution unit and the data to be evaluated coherently and the data to be evaluated non-coherently are distributed by the data distribution unit to the evaluation units.

21. The method according to claim 18, wherein the data to be evaluated coherently and the data to be evaluated non-coherently are distributed to evaluation units in the radar sensors and the evaluation units of the sensors carry out the evaluation.

22. The method according to claim 18, wherein the data to be evaluated coherently and the data to be evaluated non-coherently are transmitted to a central computing device and evaluation units of the central computing device carry out the evaluation.

23. The method according to claim 18, wherein the sensor data are transmitted as raw data or as Fourier-transformed data by the radar sensors.

24. The method according to claim 18, wherein the sensor data are preprocessed in the radar sensors and the sensor data are transmitted as preprocessed sensor data.

25. The method according to claim 18, wherein the sensor data are preprocessed in the evaluation units.

26. The method according to claim 25, wherein the preprocessing of the sensor data includes a distance and Doppler evaluation which is used to carry out an acquisition of targets using an adapted evaluation with a constant false alarm rate.

27. The method according to claim 26, wherein the overall evaluation includes a further evaluation with a lower constant false alarm rate for acquiring common targets.

28. The method according to 26, wherein targets acquired by only some of the radar sensors are evaluated only when a quality criterion is met.

29. The method according to claim 25, characterized in that the preprocessing of the sensor data includes a distance and Doppler evaluation which is used to carry out an acquisition of targets and an angle estimation using a complete evaluation with a constant false alarm rate, wherein the transmitted sensor data include a target list with phase information.

30. The method according to claim 29, wherein the evaluation for at least one angle of a target estimated during the preprocessing includes a coherent cooperative angle estimation in a definable range around the at least one estimated angle with a higher angular resolution.

31. A non-transitory machine-readable storage medium on which is stored a computer program for controlling a coherent cooperative radar sensor network which includes a plurality of radar sensors, wherein at least two of the radar sensors operate coherently, the computer program, when executed by a computer causing the computer to perform the following steps:
partitioning sensor data of the radar sensors according to a type of evaluation into data to be evaluated coherently and data to be evaluated non-coherently;
transmitting the data to be evaluated coherently and the data to be evaluated non-coherently to respectively different evaluation units, which then each carry out an individual evaluation; and
combining the individual evaluations to form an overall evaluation.

32. A coherent cooperative radar sensor network, comprising a plurality of radar sensors, wherein at least two of the radar sensors operate coherently; and
a data distribution unit;
wherein the radar network is configured to perform the following steps:
partition sensor data of the radar sensors according to a type of evaluation into data to be evaluated coherently and data to be evaluated non-coherently;
transmit the data to be evaluated coherently and the data to be evaluated non-coherently to respectively different evaluation units, which then each carry out an individual evaluation; and
combine the individual evaluations to form an overall evaluation.

33. The coherent cooperative radar sensor network according to claim 32, further comprising a central computing device which is configured to perform the steps.
